(19) United States
(12) Patent Application Publication
(10) Pub. No.: US 2019/0248228 A1
(43) Pub. Date: Aug. 15, 2019

(54) A METHOD AND A SYSTEM FOR DETERMINING TIME DATA RELATING TO A NON-COMBUSTION OUTLET PROCESS OF A FUEL GAS FROM A GAS TANK AT A VEHICLE

(71) Applicant: Scania CV AB, Södertälje (SE)

(72) Inventors: Mårten WALLENGREN, Tullinge (SE); Erik KLINGBORG, Hägersten (SE); Svante LÖTHGREN, Hägersten (SE); Christian WESSEL, Stockholm (SE)

(73) Assignee: Scania CV AB, Södertälje (SE)

(21) Appl. No.: 15/772,784

(22) PCT Filed: Dec. 2, 2016
(86) PCT No.: PCT/SE2016/051204

§ 371 Date: May 1, 2018

(30) Foreign Application Priority Data
Dec. 8, 2015 (SE) 1551604-0

(51) Int. Cl. B60K 15/03; B60K 15/035

(52) U.S. Cl. CPC B60K 15/03006; B60K 2015/03585; B60K 2015/03026; B60K 15/03519

(57) ABSTRACT

The present invention relates to a method, system, vehicle, and computer program product for determining time data relating to a non-combustion outlet process of a fuel gas from a gas tank associated with a vehicle. The method comprises providing a model for the state of fuel gas in the gas tank. The method further comprises determining time data relating to the outlet process of the fuel gas based on the model.

### CROSS-REFERENCE TO RELATED APPLICATION(S)

This application is a National Stage Application (filed under 35 § U.S.C. 371) of PCT/SE2016/051204, filed Dec. 2, 2016 of the same title, which, in turn claims priority to Swedish Application No. 1551604-0 filed Dec. 8, 2015 of the same title; the contents of each of which are hereby incorporated by reference.

### FIELD OF THE INVENTION

The present invention relates to a method and a system for determining time data relating to a non-combustion outlet process of a fuel gas from a gas tank at a vehicle. The present invention also relates to a computer program and a computer program product.

### BACKGROUND OF THE INVENTION

A vehicle tank for fuel gas is usually not equipped with a cooling device. Since the fuel gas inside the tank usually is stored far below the ambient air temperature of the tank, heat radiation will be transferred from the environment to the fuel gas. Due to this heat transfer, the pressure in the fuel tank will increase. In case the fuel gas is at least partly stored in its liquid phase, the heat transfer can warm up the gas so that it will transform into its gaseous phase. This effect increases the pressure as well and might be predominant in case it occurs. This is especially the case when an engine of the vehicle is not performing any combustion process, for example, since the engine is turned off. Even other effects might cause a pressure increase in the gas tank.

Due to the possible increase in pressure, tanks are equipped with a security valve which will open when the pressure inside the tank gets too high. Then the fuel gas will, at least partly, be released from the fuel tank so as to lower the pressure in the tank. This is to prevent, for example, a rupture of the tank due to too high pressure.

Fuel gases do, however, usually contain components which can damage the environment when being released. As an example, liquefied natural gas, LNG, usually contains high amounts of methane which acts as a greenhouse gas when released to the environment. Further, when the vehicle is located inside a space with no or with low air circulation, such as a garage, a release of the fuel gas from the tank could possible harm a person entering the garage after fuel gas has been released there. This could be, for example, through direct influences of the gas or through an explosion risk or a fire risk of the gas. There is thus a need to prevent, or at least to reduce the amount of fuel gas released to the environment from the security valve of the tank.

### SUMMARY OF THE INVENTION

One object of the present invention is to provide a method, a system, a computer program, and a computer program product which allow preventing, or at least reducing the amount of fuel gas released to the environment from a tank at a vehicle.

Another object of the present invention is to provide a method, a system, a computer program, and a computer program product which can provide information regarding a non-combustion outlet process.

Yet another object of the present invention is to provide a method, a system, a computer program, and a computer program product for determining time data relating to a non-combustion outlet process of a fuel gas from a gas tank at a vehicle.

A further object of the present invention is to provide an improved method, system, computer program, and computer program product. An even further object of the present invention is to provide an alternative method, system, computer program, and computer program product.

At least some of the objects of the present invention are achieved by a method for determining time data relating to a non-combustion outlet process of a fuel gas from a gas tank at a vehicle. The method comprises the step of providing a model for the state of the fuel gas in the gas tank. The method further comprises the step of determining time data relating to the outlet process of the fuel gas based on the model.

By determining the time data information regarding the non-combustion outlet process is generated. This allows taking actions based on the determined time data. Such actions can be managing the operation of a vehicle fleet such that the non-combustion outlet process will not occur. This would prevent emission of the fuel gas to the environment. Another action can be managing the operation of a vehicle fleet such that the amount of fuel gas released to the environment from one or more non-combustion outlet processes will be minimized. This reduces the emission of the fuel gas to the environment. Yet another action can be operating a vehicle in such a way that the fuel gas will not release substantially completely from the tank due to a non-combustion outlet process. This reduces costs for towing of vehicles, or at least costs of fuelling the vehicle outside of a fuelling station, such as a gas station. The determined information can also be used in any other application. This might allow providing new functionality to the vehicle.

In one example, the determined time data comprises a time relating to when the fuel gas will start to release from the gas tank. In one example, the determined time data comprises a time relating to when the tank will be substantially emptied from said fuel gas. This time can be a time period or a moment in time. These two examples are very important in practice. The first example can start a process of releasing fuel gas to the environment. Determining time data relating to this, can allow preventing the process, thus reducing cost for unused fuel and minimizing emissions. The second example can be the stop of a process of releasing fuel gas to the environment. Determining time data relating to this, can allow preventing cost for refuelling the vehicle outside a refuelling station.

In one example, the method further comprises the step of determining the pressure and/or the temperature in the gas tank. The model takes into account the determined pressure and/or temperature in the gas tank. The pressure and/or the temperature are important information regarding the state of the fuel gas. Determining one or both of them can give a good characterization of the state of the fuel gas.

In one example, the method further comprises the step of determining data relating to the volume of the fuel gas in its liquid phase in the gas tank. The model takes into account the determined data relating to the volume of the fuel gas in its liquid phase in the gas tank. When using gas which can be in its liquid phase, data relating to the volume of the fuel gas in its liquid phase in the tank is important information regarding the state of the fuel gas. Determining this data relating to the volume can give a good characterization of the state of the fuel gas.

In one example, the method further comprises the step of presenting the determined time data to an operator of the vehicle. When presenting this information to the operator during driving of the vehicle, the operator will be able to adapt the driving in response to said presented information. Such adaption could be adapting the driving such that a non-combustion outlet process from the tank will be prevented for a certain amount of time when turning off the combustion engine of the vehicle. A presentation can also be used to plan the further operation of the vehicle.

In one example, the determining of time data comprises performing an Euler method, such as an Euler forward method, of the model for the state of the fuel gas. This provides an easy and practical way of determining the time data.

In one example, the determining of time data comprises the step of determining a first state of the fuel gas in the gas tank. In one example, the determining of time data comprises the step of repeatedly, until a pre-determined condition is fulfilled, determining a next state of the fuel gas in the gas tank after a pre-determined time period, based on the model and based on the previous determined state of the fuel gas in the gas tank. This provides an easy and practical way of determining the time data.

At least some of the objects are achieved by a system for determining time data relating to a non-combustion outlet process of a fuel gas from a gas tank at a vehicle. The system comprises means for providing a model for the state of the fuel gas in said gas tank. The system further comprises means for determining time data relating to the outlet process of the fuel gas based on the model.

In one embodiment, the determined time data comprises a time relating to when the fuel gas will start to release from the gas tank, and/or a time relating to when the tank will be substantially emptied from the fuel gas.

In one embodiment, the system further comprises means for determining the pressure and/or the temperature in the gas tank. The model takes into account said determined pressure and/or temperature in the gas tank.

In one embodiment, the system further comprises means for determining data relating to the volume of the fuel gas in its liquid phase in the gas tank. The model takes into account the determined data relating to the volume of the fuel gas in its liquid phase in the gas tank.

In one embodiment, the system further comprises means for presenting the determined time data to an operator of the vehicle.

At least some of the objects are achieved by a vehicle which comprises a system according to the present disclosure.

At least some of the objects are achieved by a computer program for determining time data relating to non-combustion outlet process of a fuel gas from a gas tank at a vehicle. The computer program comprises program code for causing an electronic control unit or a computer connected to the electronic control unit to perform the steps of the method according to the present disclosure.

At least some of the objects are achieved by a computer program product containing a program code stored on a computer-readable medium for performing method steps according to the method of the present disclosure. The computer program is run on an electronic control unit or a computer connected to the electronic control unit.

The system, the vehicle, the computer program and the computer program product have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a better understanding of the present invention reference is made to the following detailed description when read in conjunction with the accompanying drawings:

FIG. 1 shows, in a schematic way, a vehicle according to one embodiment of the present invention;

FIG. 2a shows, in a schematic way, a system according to one embodiment of the present invention;

FIG. 2b shows, in a schematic way, a view of an example of gas tank which can be used in connection with the present invention;

FIG. 2c shows, in a schematic way, a sketch of an example of an inner configuration of gas tank which can be used in connection with the present invention;

FIG. 3 shows, in a schematic way, a flow chart over an example of a method according to the present invention; and

FIG. 4 shows, in a schematic way, a device which can be used in connection with the present invention.

### DETAILED DESCRIPTION OF THE INVENTION

Here, and in the whole document, the term “non-combustion outlet process” relates to an outlet process of the fuel gas from the gas tank where the fuel gas is not intended to be used in a following combustion process. Thus, an outlet process where the fuel gas subsequently enters a combustion engine, such as a gas engine, and then will be burned inside the combustion engine, is not considered to be a non-combustion outlet process.

Here, and in the whole document, the term “fuel gas” refers to a substance which under ordinary conditions, such as ordinary atmospheric pressure and ordinary atmospheric temperature, is basically only in its gaseous phase. A prominent, non-limiting example of a fuel gas is liquefied natural gas, LNG. Many more examples of fuel gases are known in the art. The term “fuel gas” does thus not relate to petrol, diesel, or the like, which to a very large extend are in its liquid phase under ordinary conditions.

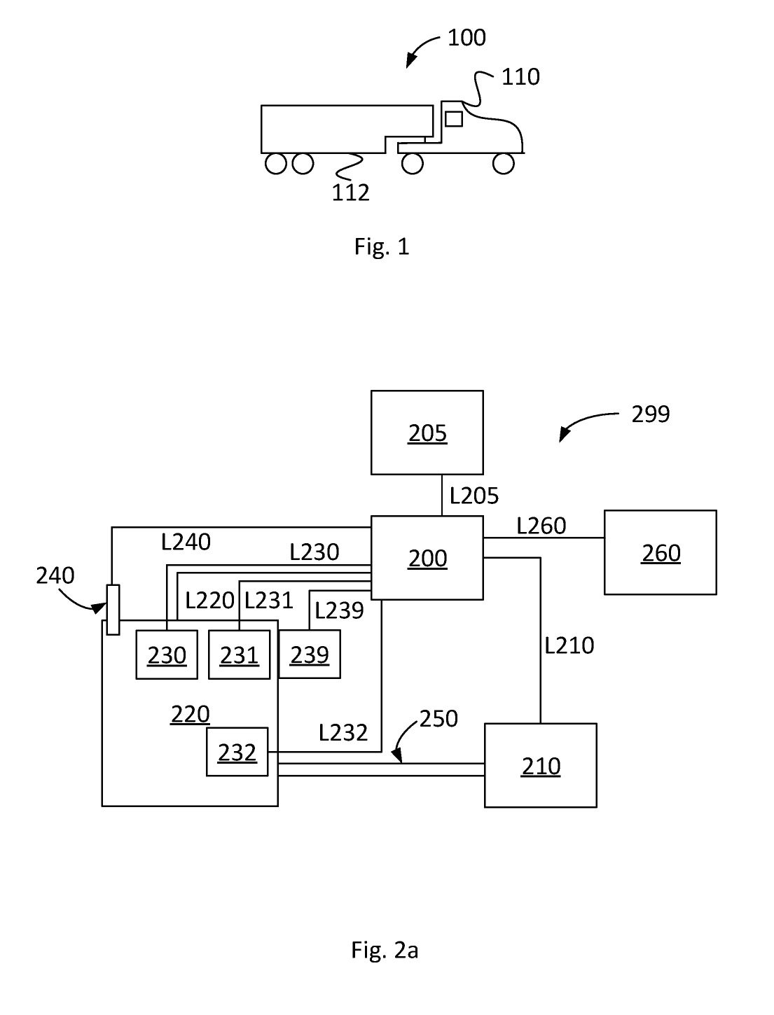

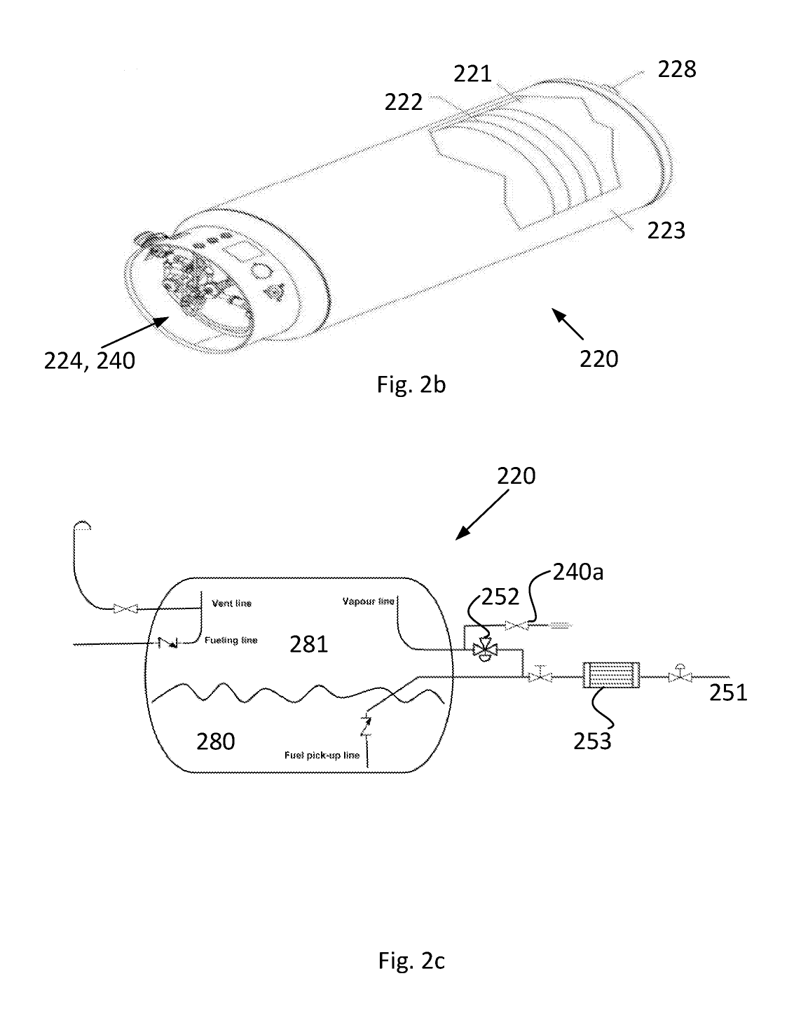

FIG. 1 shows a side view of a vehicle 100. In the shown example, the vehicle comprises a tractor unit 110 and a trailer unit 112. The vehicle 100 can be a heavy vehicle such as a truck. The vehicle can have a cryogenic tank. In one example, no trailer unit is connected to the vehicle 100. The vehicle 100 can comprise a combustion engine. The combustion engine can, for example, be a gas engine or a diesel engine. The vehicle can comprise a cryogenic engine. The vehicle 100 comprises a system 299, se FIG. 2a. The system 299 can be arranged in the tractor unit 110.

In one example, the vehicle 100 is a bus. The vehicle 100 can be any kind of vehicle comprising a cryogenic tank. Other examples of vehicles comprising a gas engine are boats, passenger cars, construction vehicles, and locomotives.

The innovative method and the innovative system according to one aspect of the invention are also well suited to, for example, systems which comprise industrial engines and/or engine-powered industrial robots.

The term “link” refers herein to a communication link which may be a physical connection such as an opto-electronic communication line, or a non-physical connection such as a wireless connection, e.g. a radio link or microwave link.

FIG. 2a shows, in a schematic way, a system 299 according to one embodiment of the present invention. Not all elements in the system 299 are necessary to perform the invention. Instead, an embodiment of the system has been chosen which well explains the principle of the invention. The system 299 comprises a tank 220. In the following, the expressions tank and gas tank are used interchangeably. The tank 220 is arranged to store a fuel gas for the vehicle. The tank 220 is thus preferably a storage tank. The tank 220 can be a pressurized tank. A possible embodiment of the tank 220 is explained in more detail in relation to FIG. 2b. The fuel gas can be any kind of fuel gas, such as, for example, liquefied natural gas, LNG, liquefied petroleum gas, LPG, liquefied hydrogen, or liquefied nitrogen. The fuel gas can be any kind of cryogenic liquid or fuel that exists in both liquid and gas phase in a cryogenic container.

In relation to the system 299 a combustion engine 210 is depicted. The combustion engine 210 can be a gas engine. A connection arrangement 250 connects the tank 220 with the combustion engine 210. The connection arrangement 250 can comprise pipes, tubes, hoses, or the like. The connection arrangement 250 is arranged to allow transport of fuel gas from the tank 220 to the combustion engine 210.

The system 299 further comprises a first control unit 200. Said first control unit 200 is arranged for communication with said combustion engine 210 via a link L210. Said first control unit 200 is arranged to receive information from said combustion engine 210. Said received information can comprise information relating to the fact whether combustion processes are taken place at the combustion engine 210 or not.

The tank 220 comprises an outlet arrangement 240. The outlet arrangement 240 is arranged to allow a non-combustion outlet process. In one example, the outlet arrangement 240 comprises a so-called boil-off valve. In one example, the outlet arrangement 240 is arranged to allow release of the fuel gas from the tank. The allowance can be dependent on a pre-determined condition inside the tank 220. As an example, the outlet arrangement can be arranged to allow release of the fuel gas from the tank 220 if the pressure inside the tank 220 is above a pre-determined value. In one example, said pre-determined value for the pressure inside the tank 220 is 16 bar. The release of the fuel gas can thus be conditioned on security considerations for the tank 220. As an example, the outlet arrangement 240 can allow release of the fuel gas to prevent damages of the tank 220, such as, for example, due to too high pressure.

Said first control unit 200 is arranged to control operation of said outlet arrangement 240. Said control can comprise opening and/or closing of said outlet arrangement 240. Said first control unit 200 is arranged for communication with said outlet arrangement 240 via a link L240. Said first control unit 200 can be arranged to receive information from said outlet arrangement 240.

The system 299 comprises a first sensor arrangement 230. The first sensor arrangement 230 can be arranged to determine a temperature inside the tank 220. The first sensor arrangement 230 can comprise a first temperature sensor. The first temperature sensor is preferable arranged inside the tank 220.

Said first control unit 200 is arranged to control operation of said first sensor arrangement 230. Said first control unit 200 is arranged for communication with said first sensor arrangement 230 via a link L230. Said first control unit 200 can be arranged to receive information from said first sensor arrangement 230.

The system 299 comprises a second sensor arrangement 231. The second sensor arrangement 231 can be arranged to determine a pressure inside the tank 220. Said pressure inside the tank 230 is preferably the pressure of the fuel gas in the tank 220. The second sensor arrangement 231 can comprise a pressure sensor. The pressure sensor is preferable arranged inside the tank 220. In one example, the pressure sensor is arranged at the connection arrangement 250. From the pressure in the connection arrangement 250 it is possible to derive the pressure in the gas tank 220. In many vehicles a pressure sensor is already placed at the connection arrangement 250. Thus using a pressure sensor there can lower the cost of the system 299.

Said first control unit 200 is arranged to control operation of said second sensor arrangement 231. Said first control unit 200 is arranged for communication with said second sensor arrangement 231 via a link L231. Said first control unit 200 can be arranged to receive information from said second sensor arrangement 231.

The system 299 comprises a third sensor arrangement 232. The third sensor arrangement 232 can be arranged to determine data relating to the volume of a liquid in the gas tank 220. As an example, the third sensor arrangement 232 can be arranged to determine a level for a liquid inside the tank. Since the geometrical configuration of the tank 220 is known and does not change significantly during operation, knowing the level of the liquid can be directly transferred to the volume of the liquid. Said level for a liquid can be the level of the fuel gas in its liquid form. The third sensor arrangement 232 can comprise a level sensor. The level sensor is preferably arranged inside the tank 220. This is, however, not a requirement. An example of a level sensor which can be arranged outside the tank is an optical sensor, in case the tank is at least partly transparent for the wavelengths used by the optical sensor.

Said first control unit 200 is arranged to control operation of said third sensor arrangement 232. Said first control unit 200 is arranged for communication with said third sensor arrangement 232 via a link L232. Said first control unit 200 can be arranged to receive information from said third sensor arrangement 232.

The system 299 comprises a fourth sensor arrangement 239. Said fourth sensor arrangement 239 can be arranged to determine an ambient temperature T_{amb} of the tank 220. Said ambient temperature relates to a temperature outside the tank 220. Said fourth sensor arrangement can comprise a second temperature sensor. The second temperature sensor is preferably arranged outside the tank 220. The second temperature sensor does not necessarily need to be at the tank 220. In one example, the second temperature sensor is at another part of the vehicle 100. Usually the ambient temperature around the vehicle is not differing too much between different parts of the vehicle. Therefore another position at the vehicle might give representative ambient temperature values for the tank 220. In one example, said fourth sensor arrangement 239 is arranged to receive temperature information relating to the ambient temperature of the vehicle via a link (not shown in the figure). As an example, the fourth sensor arrangement can be arranged to receive temperature information from a weather information provider. This is an example where there is no need for a second temperature sensor at the vehicle.

The fourth sensor arrangement 239 is in one example arranged to determine further ambient conditions of the tank 220. Examples of further ambient conditions are wind speed, amount and kind of precipitation, amount and kind of solar radiation relating to the place of the vehicle, or the like. The fourth sensor arrangement 239 can comprise one or more sensors for determining said further ambient conditions. One example of such a sensor is a wind sensor. In one example, the fourth sensor arrangement 239 is arranged to receive said further ambient conditions from a weather information provider.

When relating to the ambient temperature or further ambient conditions, this information can be time-dependent. As an example, the provided information from the weather information provider can be time-dependent. This can include predictions of the ambient temperature and/or further ambient conditions. Thus, in one example a time series of the ambient temperature is provided from the weather information provider which comprises a prediction of the ambient temperature for the next five days.

Said first control unit 200 is arranged to control operation of said fourth sensor arrangement 239. Said first control unit 200 is arranged for communication with said fourth sensor arrangement 239 via a link L239. Said first control unit 200 can be arranged to receive information from said fourth sensor arrangement 239.

Said first control unit 200 is arranged to control operation of the tank 220. Said first control unit 200 is arranged for communication with said tank 220 via a link L220. Said first control unit 200 can be arranged to receive information from said tank 220. Said first control unit 200 can thus control any of the elements of the tank 220 described in relation to FIG. 2c. Said first control unit 200 can thus receive information from any of the elements of the tank 220 described in relation to FIG. 2c.

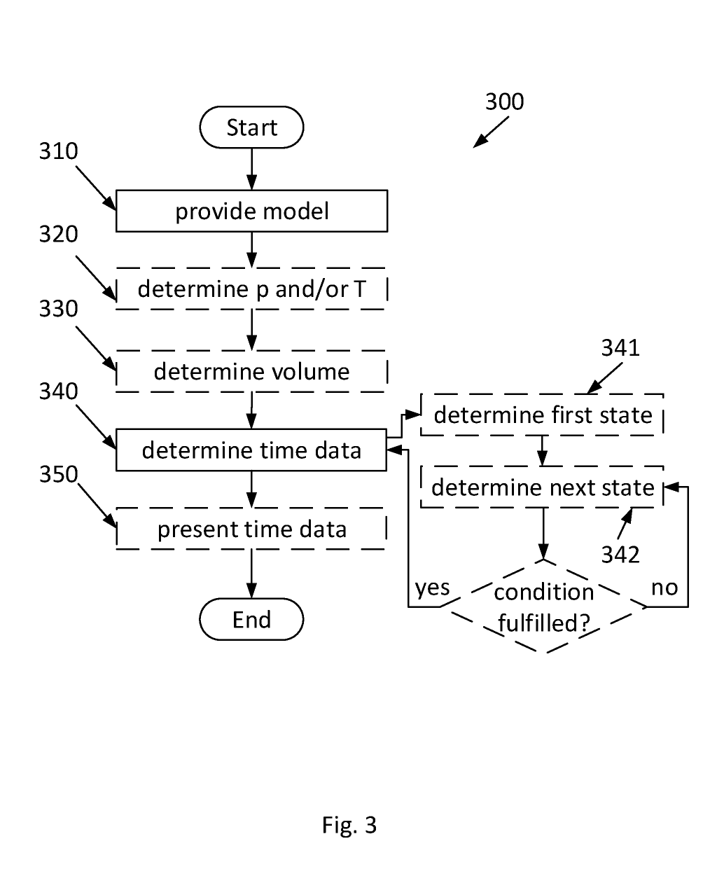

The first control unit 200 can provide a model for the state of the fuel gas in the tank 220. The first control unit 200 is arranged to determine time data relating to the outlet process of the fuel gas based on the model. This is described in more detail in relation to FIG. 3.

A second control unit 205 is arranged for communication with the first control unit 200 via a link L205 and may be detachably connected to it. It may be a control unit external to the vehicle 100. It may be adapted to conducting the innovative method steps according to the invention. The second control unit 205 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as determining time data relating to a non-combustion outlet process of a fuel gas from a gas tank at a vehicle. The innovative method may be conducted by the first control unit 200 or the second control unit 205, or by both of them.

The system 299 comprises a presenting arrangement 260. Said presenting arrangement 260 is arranged for presenting said determined time data to an operator of the vehicle. The presenting arrangement can comprise any of a screen, a speaker, a display, an indicator or the like. The presenting can be optically, acoustically, and/or tactile. In one example, said time data is presented via a voice. In one example, said time data is presented on a screen and/or a display. In one example, said time data is presented on an analogue presenting means, for example via a pointer. In one example, said presenting means can be outside the vehicle. In one example, said presenting means is a mobile device. In one example, said presenting means are at an operating centre of a coach company, shipping company, or the like.

Said first control unit 200 is arranged to control operation of said presenting arrangement 260. Said first control unit 200 is arranged for communication with said presenting arrangement 260 via a link L260. Said first control unit 200 can be arranged to receive information from said presenting arrangement 260.

It should be emphasized that most of the aforementioned components are facultative. As an example, there is no need to have both the first and the second sensor arrangement 230, 231. From the determined temperature inside the tank 220, the pressure inside the tank 200 can be derived, and vice versa.

In a minimal version of the invention, none of the first-fourth sensor arrangements 230-232, 239 is needed. When knowing the state of the fuel gas at one moment of time, it is in principle possible to determine the state of the fuel gas at any later moment of time when using a model for the state of the fuel gas in the gas tank 220. Thus, it is in principle enough to determine the state of the gas in the tank 220 once when the tank is used for the first time 220. This state can be determined based on a known geometry of the tank and a known state of the fuel gas which is transferred from a different storage tank, such as a tank at a gas station, to the tank 220 at the vehicle.

FIG. 2b shows, in a schematic way, a view of an example of a gas tank 220 which can be used in connection with the present invention. The tank 220 comprises an inner vessel 221. In the inner vessel the fuel gas such as LNG can be stored. An insulation arrangement 222 is arranged around the inner vessel 221. This insulation arrangement 222 can comprise insulation material. This insulation arrangement can comprise aluminium foils or any other reflective shield material. The tank 220 comprises an outer jacket 223. Preferably, there is a vacuum between the inner vessel 221 and the outer jacket 223. In one example, the vacuum is between the insulation arrangement 222 and the outer jacket 223. An emergency evacuation path 228 is arranged at one side of the tank 220. The other side of the tank comprises a connection arrangement 224. The connection arrangement can be arranged to provide a connection to the combustion engine 210. Also an outlet arrangement 240, such as a boil-off valve, is arranged at this side of the tank 220. Even a secondary outlet arrangement is situated there. The secondary outlet arrangement is in one example a back-up outlet arrangement. The back-up outlet arrangement is arranged to operate in case the outlet arrangement 240 malfunctions.

FIG. 2c shows, in a schematic way, a sketch of an example of an inner configuration of a gas tank 220 which can be used in connection with the present invention. At the bottom of the tank the liquid phase 280 of the fuel gas is indicated. Above the liquid phase, the fuel gas is present in its gaseous phase 281. The tank comprises an outlet 251 to the combustion engine. The outlet 251 can be connected to the connection arrangement 250.

In one embodiment, the tank 220 is arranged to transmit fuel gas in its gaseous phase to the combustion engine when the pressure is above a pre-determined threshold, for example 10 bar. This can be done by opening a phase selector 252. The gas is then transported to a heat exchanger 253 and further to the combustion engine. In case the pressure is below said pre-determined threshold, for example 10 bar, the phase selector 252 is closed and the fuel gas is transported from its liquid phase to the heat exchanger 253, where it is changing phase to the gaseous phase, and is then transported to the combustion engine.

Such an arrangement will keep the pressure around the pre-determined threshold during operation of the combustion engine. However, in case a lot of fuel gas is consumed by the combustion engine, the pressure in the tank may drop below the pre-determined threshold.

A boil-off valve 240a is present at one side of the tank.

FIG. 2c does only show one possible embodiment of a tank. Other configurations are possible, such as tanks containing a pump configuration, or the like.

FIG. 3 shows, in a schematic way, a flow chart over an example of a method 300 according to the present invention. The method 300 is a method for determining time data relating to a non-combustion outlet process of a fuel gas from a gas tank at a vehicle. The non-combustion outlet process preferably relates to a controlled outlet process, i.e. an outlet process which occurs under pre-determined conditions. An example of such an outlet process under pre-determined condition is the opening of an outlet arrangement under a pre-determined condition, such as when a pre-determined pressure is reached on one side of the outlet arrangement. Examples of non-controlled outlet processes are accidental outlet processes, such as outlet process due to material failure, material disruption, or the like.

In one example the method is performed at a pre-determined condition. Such a pre-determined condition can be the turning-off of the combustion engine, or a similar condition relating to the turning-off of the combustion engine. Such a similar condition can be the release of the ignition key from the vehicle, the opening of a door, such as the door for the driver, the locking of the vehicle, or the like. The method starts with step 310.

In step 310, a model for the state of the fuel gas in the gas tank is provided. In one example, the model assumes that the fuel gas consists of methane. In the following, it will be described how the model can look like if methane is used. The described method is, however, applicable to any other component of the fuel gas as well. The method is thus, for example, applicable to ethane, propane, butane, or the like. In case the fuel gas is a mixture of different gases, the model can be applied to every component of the fuel gas and then be combined according to the composition of the fuel gas.

In one example, the model is based on the assumption that a saturated state is present in the tank. The term saturated state relates in one example to the fact that there is a thermodynamic equilibrium between the fuel gas in its gaseous and its liquid phase. Since the tank usually is well isolated against the environment, and the amount of heat transfer from the environment to the tank thus is quite limited, this assumption is in general well justified. In one example, the model is based on the assumption, that the fuel gas in its gaseous and its liquid phase has the same temperature. In one example, the model is based on the assumption that the heat transfer can be described by a linear model. In one example, the heat transfer from the environment to the tank is proportional to the temperature gradient between the ambient temperature T_{amb} of the tank and the temperature inside the tank.

In one example, the state x of the gas is described as x=(T, p, Vₗ, m_{g}, mₗ), where T denotes the temperature of the gas in the tank, and thus, in case a saturated state is assumed, also the liquid in the tank, p denotes the pressure of the gas in the tank, Vₗ, denotes the volume of the gas in the liquid phase, m_{g} denotes the mass of the fuel gas in its gaseous phase, and mₗ denotes the mass of the fuel gas in its liquid phase. In one example, one or more of the variable of x are not used for the state. As an example, when no outlet process of the fuel gas takes place, the sum of the masses of the fuel gas in its gaseous and its liquid phase will be constant. Thus, it is possible to derive one quantity from the other. Further, in one example, it is not important to take the mₗ and m_{g} into account at all, especially if no outlet process of the fuel gas takes place.

In one example, T can be derived from p, or vice versa. This is especially the case if a saturated state is assumed in the model. Especially when one quantity is derivable from another quantity, it is not needed to describe both quantities in the state of the tank/fuel gas.

In one example, the model takes into account a state of the environment and/or a state of the flow of the fuel gas from and/or to the tank. In one example, the state of the environment takes into account any of the ambient temperature of the tank, wind speed, amount and kind of precipitation, amount and kind of solar radiation relating to the place of the vehicle, or the like. In one example, the vehicle is usually parked in a garage with substantially always the same temperature, no wind speed, no precipitation, substantially no solar radiation, and the like. In that case, the state of the environment there is no need to take the state of the environment into account. A person skilled in the art will realize which of the above quantities are important in a given situation and which not. Less variables will lower the complexity of the model, but might increase uncertainty. The state of the flow of the fuel gas from and/or to the tank can take into account any of a mass flow \dot{m}_{e,g} of the fuel gas in its gaseous phase from the tank to the gas engine, a mass flow \dot{m}_{e,l} of the fuel gas in its liquid phase from the tank to the gas engine, a mass flow \dot{m}ᵥ of the fuel gas into the environment/atmosphere, for example due to the pressure in the tank being too high, and/or the mass flow of the fuel gas into the tank, for example due to fuelling the tank at a gas station. In one example, some or all of the above quantities are zero. This is for example the case if the vehicle is parked and the method 300 will be used to determine the time until the gas in the tank will arrive at a pressure threshold which will cause a boil-off valve to open. In one example, the model takes into account, that the mass is constant, for example that \dot{m}_{g}=\dot{m}_{BOG}−\dot{m}_{e,g}−\dot{m}ᵥ, and that \dot{m}ₗ=−\dot{m}_{BOG}−\dot{m}_{e,l}, wherein \dot{m}_{g} denotes the total mass flow in the gaseous phase, \dot{m}ₗ denotes the total mass flow in the liquid phase, and \dot{m}_{BOG} denotes the mass flow between the liquid and the gaseous phase. In one example, said mass flow between the liquid and the gaseous phase takes into that there is a thermodynamic equilibrium between the fuel gas in its gaseous and its liquid phase. In one example, this is expressed as the equation

$${\dot{m}}_{BOG} = \frac{C ( {T}_{amb} - T ) - ( {c}_{p , g} {m}_{g} + {c}_{p , l} {m}_{l} ) \dot{T}}{{L}_{v} ( T )} ,$$

wherein C denotes a constant relating to the insulation of the tank, c_{p,g} denotes the specific heat capacity of the fuel gas in its gaseous phase, c_{p,l} denotes the specific heat capacity of the fuel gas in its liquid phase, \dot{T} denotes the temperature change, and Lᵥ(T) denotes the latent heat of vaporization. In one example, the latent heat of vaporization is modelled as being non-constant. In one example, the latent heat of vaporization is modelled as being temperature dependent and/or pressure dependent.

When providing a model for the state of the fuel gas in the gas tank of the vehicle, such a model differs in general greatly from a model for the state of the fuel gas in a storage tank which is not carried by the vehicle, such as for example, a storage tank at a LNG transport ship, or at a harbor. This is due to the fact that a vehicle in general does not have any reliquefaction system. In a reliquefaction system the released boil-off gas is in one example reliquefied with compressors in stages. Also the pressure in the tank varies greatly. As an example, when fuelling the vehicle, the pressure in the tank may be 2 bar. This can be the case if the gas pressure is 2 bar in the storage tank at a gas station. The pressure in the tank of the vehicle can reach up to a pre-determined threshold, such as 16 bar, when the vehicle is not operated for a while. Above said pre-determined threshold, the outlet arrangement might release the gas from the tank. Since a model for a storage tank which is not carried by the vehicle in general assumes constant pressure and therefore constant density and latent heat of vaporization in the storage tank, such a model can in general not be transferred to the tank of the vehicle.

In one example, when assuming that a saturated state is present in the tank that gives a relation between T and p, and/or between p and the gas density, and/or between T and the liquid density. Such relations for a specific gas can be empirically determined and are usually publically available for the most common gases.

The provided model can be stored in the first or the second unit 200, 205. After step 310, the method continues with the optional step 320.

In step 320, the pressure and/or the temperature in the gas tank is determined. In one example this is performed by a pressure sensor and/or a temperature sensor. In general, the pressure can be derived from the temperature, and vice versa. Thus, in general it is enough to only determine one of temperature and/or pressure. However, determining both independently can have the advantage of adding redundancy to the method and cross-check, whether the pressure and the temperature values are reasonable, respectively. Determining both independently can also be used to check the composition of the fuel gas. As has been described in relation to FIG. 2a, it is in principle possible to predict the state of the fuel at any later time, based on an initial determination of the state, such as during the first fuelling of the tank. Step 320 is thus optional, since, for example, such a prediction could give the same information as step 320. After step 320 an optional step 330 is performed.

In the optional step 330, data relating to the volume of the fuel gas in its liquid phase in the gas tank is determined. In one example, the step comprises determining the volume of the fuel gas in its liquid phase in the gas tank. In one example, the step comprises determining a level of the liquid phase of the fuel gas in the tank. This can be performed by a level sensor. From this level, the volume of the fuel gas in its liquid phase in the gas tank can then be derived when knowing the geometry of the tank. After the optional step 330, step 340 is performed.

In step 340, time data relating to the outlet process of the fuel gas based is determined based on said model. In one example, said determined time data comprises a time relating to when said fuel gas will start to release from said gas tank. This time is often referred to as the hold time of tank. In one example, said release relates to the fact that a pre-determined threshold for the pressure inside the tank has been achieved. In one example, said release relates to a security release from the tank, such as to avoid damage to the tank. Said release can relate to the opening of a so-called boil-off valve.

It is especially useful to perform the method, and thus step 340, to determine what happens in the tank when the vehicle is not operated. Said non-operating of the vehicle can relate to the fact that the combustion engine of the vehicle is turned off. During operation of the combustion engine, the pressure in the tank is usually lowered or kept constant. This is due to the fact that a release of fuel gas from the tank to the combustion engine will be the predominant effect and that this release lowers pressure in the tank. Usually, the tank is arranged to keep a certain lower level of pressure in the tank, such as, for example, 10 bar. This can be achieved by other measures. In that case the pressure in the tank is approximately constant. A non-combustion outlet process of the fuel gas from the gas tank at the vehicle will thus usually not take place during operation of the combustion engine. Such a non-combustion outlet process of the fuel gas from the gas tank at the vehicle takes, however, usually place at some moment of time after turning off of the combustion engine. This is, for example, due to heat transfer from the environment to the tank, resulting in too high pressure so that fuel gas will release due to security reasons. It is thus advantageous to determine the time period after which such release will occur, or to determine the moment in time when such release will occur. When knowing said time period/said moment in time, an operator can act accordingly to avoid such a release. Said time period is typically in the order of a few days after turning off of the combustion engine. However, if the combustion engine only has been operated shortly and the pressure in the tank was close to the threshold when fuel gas will be released due to security reasons, the pressure in the tank might not have been lowered substantially. In that case said time period can be minutes or hours. When having information regarding the time period, an operator of the vehicle can, for example, decide to use a vehicle where a release will appear shortly instead of a vehicle where a release will only appear after a longer period of time. This might be especially the case when having access to a larger fleet of vehicles, or at least to two vehicles.

In one example, said determined time data comprises a time relating to when the tank will be substantially emptied from the fuel gas. Said term substantially emptied can relate to the fact that the pressure of the fuel gas in the gas tank is below a pre-determined threshold that the volume of the fuel gas in its liquid form is below a pre-determined threshold, or any other similar indication. In one example said time is a moment in time when the tank will be substantially emptied. In one example said time is a time period when the tank will be substantially emptied. When the tank is substantially emptied from the fuel gas, the vehicle might be no longer operated due to lack of fuel, or might only be operated for a limited time/distance. It is thus advantageous for an operator of the vehicle to know when this will occur, so that the vehicle can be transported to a fuel station for refuelling in due time. In one example, the substantially emptying of the fuel gas relates to a non-combustion process, and thus not to the fact that the tank is emptied due to driving. If, for example, the boil-off valve opens as described above due to too high pressure in the tank, fuel gas is usually released until the pressure in the tank is below a second pre-determined threshold. After some time, the pressure will, however, have risen again due to heat transfer from the environment, so that the boil-off valve will open again. This process can then repeat until the tank is substantially emptied from fuel gas. In one example the expression substantially emptied relates to the fact that all the fuel gas in the tank is in its gaseous phase, has the same temperature as the ambient temperature of the tank and a pressure below the pressure where the outlet arrangement, such as the boil-off valve, opens.

In one example, step 340 comprises performing an Euler method, such as an Euler forward method, of said model for the state of said fuel gas. In one example, a pressure difference between a pressure value when the non-combustion outlet process of the fuel gas from the gas tank at the vehicle will occur and between a current pressure value in the tank is determined. This pressure difference can then be divided by a pressure gradient, i.e. a change of pressure over time. In one example, the pressure gradient is determined by the model which is provided in step 310. In one example, the pressure gradient is calibrated. From said division the time period until the non-combustion outlet process of the fuel gas from the gas tank at the vehicle will occur can be determined. For increasing accuracy, said pressure difference can be divided into a number n of smaller pressure differences. Said division can then be applied to each of then smaller pressure differences. In such a way a more accurate value for the time can be determined.

In one example, the current pressure is 10 bar and the pressure when the boil-off valve will open is 16 bar. In one example, the total pressure difference of 6 bar will be divided in three steps of 2 bars each, i.e. from 10 bar to 12 bar, from 12 bar to 14 bar, and from 14 bar to 16 bar. The division of the respective pressure difference by the pressure gradient from the model with the respective starting point, i. e. 10 bar, 12 bar, and 14 bar, is calculated for achieving the time which each pressure raising takes. The three such determined times are then added to arrive at the time when the boil-off valve will open. In this case n=3.

In general, a higher n gives a higher accuracy. It should, however, be noted that a higher n gives higher calculation time. According to an embodiment, n=10 gives a good compromise between accuracy and calculation time. In a given example such a value caused an error between a determined time and a measured time of only a fraction of a percent, which is totally acceptable. If, however, ambient conditions of the tank are changing substantially, higher values of n might be recommended. Even a value of n in the order of hundred thousand can still give calculation times below one second with current control units, which usually is acceptable.

In one example, step 340 comprises step 341. In step 341 a first state of the fuel gas in the gas tank is determined. In one example, said first state is the current state of the fuel gas. The determination of the first state can be bases on the determined pressure and/or temperature from step 320, and/or the determined data relating to the volume of the fuel gas in its liquid phase from step 330. The determined first state can comprise any of the other values related to a state of the gas which have been discussed before. After step 341, in one example a step 342 is performed.

In one example, step 340 comprises step 342. In step 342 a next state of the fuel gas in the gas tank after a pre-determined time period is determined, based on the model and based on the previous determined state of the fuel gas in the gas tank. Said determination is in one example also based on one or more ambient values of the gas tank. Such ambient values are in one example an ambient temperature, or any of the other values discussed before in this disclosure.

Step 342 can be repeated until a pre-determined condition is fulfilled. For example, after the initial state a second state is determined in step 342 based on the model and based on the initial state. In the next run of step 342, a third state is determined based on the model and based on the second state, and so on. Said pre-determined condition relates in one example to a pre-determined pressure in the gas tank. Said pre-determined pressure can be the pressure when the boil-off valve opens. Thus, in one example, when the state determined in step 342 has a pressure equal to or higher than the pre-determined pressure, the repetition of step 342 is stopped. In one example, the sum of the pre-determined time periods from each time performing step 342 is said determined time data relating to the outlet process of the fuel gas. In general, the shorter the time periods when performing step 342, the more accurate will the determined time be. There will be a bias error when taking too long time steps. Too short time steps will increase calculation time. As an example, time steps of one hour between the different determined states when performing step 342 might perform a good compromise between accuracy of the determined time data relating to a non-combustion outlet process of the fuel gas and a short calculation time.

After step 340, an optional step 350 is performed.

In the optional step 350, said determined time data is presented to an operator of the vehicle. In one example, the presentation is acoustical, optical and/or tactile. Further details of the presentation have been discussed in relation to FIG. 2. Said presentation can, for example be “In 15 hours a gas release from the tank will occur”, or “In 6 days the tank will be substantially empty”. After step 350 the method 300 ends.

In relation to method 300 the steps have been described in a certain order. The steps can, however, also be performed in different orders, or simultaneously. The only limitation in the order arises if one step needs information which has to be provided by another step.

The method 300 is preferably performed in relation to a turning-off of the combustion engine. Such a turning-off will cause a slow raising of the pressure in the tank and thus eventually the opening of a boil-off valve, unless the combustion engine is not turned on again before the pressure gets too high. Thus, when turning off the combustion engine, the determined time data relating to a non-combustion outlet process of the fuel gas is important information to the operator of the vehicle. The operator can then plan to use the vehicle again before the release of the fuel gas occurs, or at least before the fuel tank is substantially empty. Thus, in one example, the performing of method 300 can be triggered by the turning-off of the combustion engine, or a similar action indicative thereof, as has been described before. In another example, the method 300 can be performed repeatedly during operation of the vehicle. In one example, the method determines a time relating to when a non-combustion outlet process of the fuel gas from the gas tank will occur given the combustion engine would be turned off at that moment. If an operator plans to use the vehicle again after, for example, a number of days or hours, the operator could then continue operating the vehicle at the moment until the pressure in the tank has lowered so much that the determined time until the non-combustion outlet process of the fuel gas from the gas tank will take place is that number of days or hours, or longer.

In one example, the determined time of step 340 is a time how long the operator has to drive the vehicle to allow a turning-off of the combustion engine for a pre-determined amount of time without releasing fuel gas from the tank. As an example, a presented message in step 350 can then be “If you drive 15 more minutes, you can turn off the combustion engine for 48 hours without releasing gas.”

The inventive method, and embodiments thereof, as described above, may at least in part be performed with/using/by at least one device. The inventive method, and embodiments thereof, as described above, may be performed at least in part with/using/by at least one device that is suitable and/or adapted for performing at least parts of the inventive method and/or embodiments thereof. A device that is suitable and/or adapted for performing at least parts of the inventive method and/or embodiments thereof may be one, or several, of a control unit, an electronic control unit (ECU), an electronic circuit, a computer, a computing unit and/or a processing unit.

With reference to the above, the inventive method, and embodiments thereof, as described above, may be referred to as an, at least in part, computerized method. Said method being, at least in part, computerized meaning that it is performed at least in part with/using/by said at least one device that is suitable and/or adapted for performing at least parts of the inventive method and/or embodiments thereof.

With reference to the above, the inventive method, and embodiments thereof, as described above, may be referred to as an, at least in part, automated method. Said method being, at least in part, automated meaning that it is performed with/using/by said at least one device that is suitable and/or adapted for performing at least parts of the inventive method and/or embodiments thereof.

The method 300 can be implemented on an existing control unit of a vehicle. This can, for example, be performed via an update. This would not require any additional components and is thus a very cost-efficient way. Alternatively, or additionally, the method 300 could be implemented on a control unit especially for this purpose. This has the advantage that such a control unit can be especially designed for that purpose. Further, less effort has to be put on lowering calculation time.

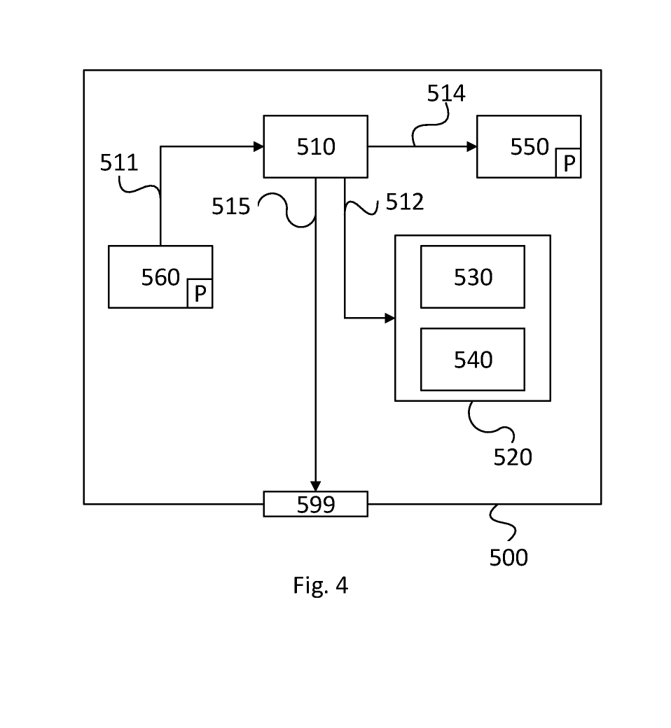

FIG. 4 is a diagram of one version of a device 500. The control units 200 and 205 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program comprises routines for determining time data relating to a non-combustion outlet process of a fuel gas from a gas tank at a vehicle.

The computer program P may comprise routines providing a model for the state of said fuel gas in said gas tank. This may at least partly be performed by means of said first control unit 200.

The computer program P may comprise routines for determining the pressure and/or the temperature in the gas tank. This may at least partly be performed by means of said first control unit 200 controlling operation of the first and second sensor arrangement 230, 231. Said determined pressure and/or temperature may be stored in said non-volatile memory 520.

The computer program P may comprise routines for determining data relating to the volume of the fuel gas in its liquid phase in the gas tank. This may at least partly be performed by means of said first control unit 200 controlling operation of said third sensor arrangement 270. Said determined data relating to the volume of the fuel gas in its liquid phase in the gas tank may be stored in said non-volatile memory 520.

The computer program P may comprise routines for determining time data relating to the outlet process of the fuel gas based on said model. This may at least partly be performed by means of said first control unit 200. Said determined time data may be stored in said non-volatile memory 520.

The computer program P may comprise routines for presenting said determined time data to an operator of the vehicle. This may at least partly be performed by means of said first control unit 200 controlling operation of the presenting arrangement 260.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L205, L210, L250-255, and L270, for example, may be connected to the data port 599 (see FIG. 2).

When data are received on the data port 599, they can be stored temporarily in the second memory element 540. When input data received have been temporarily stored, the data processing unit 510 can be prepared to conduct code execution as described above.

Parts of the methods herein described may be conducted by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

1. A method for determining time data relating to a non-combustion outlet process of a fuel gas from a gas tank associated with a vehicle, the method comprising the steps:
providing a model for the state of said fuel gas in said gas tank; and
determining time data relating to the outlet process of the fuel gas based on said model.

2. The method according to claim 1, wherein said determined time data comprises a time relating to when said fuel gas will start to release from said gas tank, and/or a time relating to when the tank will be substantially emptied from said fuel gas.

3. The method according to claim 1 further comprising the step of:
determining the pressure and/or the temperature in the gas tank, wherein said model takes into account said determined pressure and/or temperature in the gas tank.

4. The method according to claim 1 further comprising the step of:
determining data relating to the volume of the fuel gas in its liquid phase in the gas tank, wherein said model takes into account said determined data relating to the volume of the fuel gas in its liquid phase in the gas tank.

5. The method according to claim 1 further comprising the step of:
presenting said determined time data to an operator of the vehicle.

6. The method according to claim 1, wherein said determining of time data comprises performing an Euler method of said model for the state of said fuel gas.

7. The method according to claim 1, wherein said determining of time data comprises the steps:
determining a first state of the fuel gas in said gas tank; and
repeatedly, until a pre-determined condition is fulfilled, determining a next state of the fuel gas in said gas tank after a pre-determined time period, based on said model and based on the previous determined state of the fuel gas in said gas tank.

8. A system for determining time data relating to a non-combustion outlet process of a fuel gas from a gas tank at a vehicle, the system comprising:
means for providing a model for the state of said fuel gas in said gas tank; and
means for determining time data relating to the outlet process of the fuel gas based on said model.

9. The system according to claim 8, wherein said determined time data comprises a time relating to when said fuel gas will start to release from said gas tank, and/or a time relating to when the tank will be substantially emptied from said fuel gas.

10. The system according to claim 8, further comprising:
means for determining the pressure and/or the temperature in the gas tank, wherein said model takes into account said determined pressure and/or temperature in the gas tank.

11. The system according to claim 8 further comprising:
means for determining data relating to the volume of the fuel gas in its liquid phase in the gas tank, wherein said model takes into account said determined data relating to the volume of the fuel gas in its liquid phase in the gas tank.

12. The system according to claim 8 further comprising:
means for presenting said determined time data to an operator of the vehicle.

13. (canceled)

14. (canceled)

15. (canceled)

16. The method according to claim 1, wherein said determining of time data comprises performing an Euler forward method of said model for the state of said fuel gas.

17. A vehicle comprising a system for determining time data relating to a non-combustion outlet process of a fuel gas from a gas tank at a vehicle, the system comprising:
means for providing a model for the state of said fuel gas in said gas tank; and
means for determining time data relating to the outlet process of the fuel gas based on said model.

18. The vehicle according to claim 17, wherein said determined time data comprises a time relating to when said fuel gas will start to release from said gas tank, and/or a time relating to when the tank will be substantially emptied from said fuel gas.

19. The vehicle according to claim 17 further comprising:
means for determining the pressure and/or the temperature in the gas tank, wherein said model takes into account said determined pressure and/or temperature in the gas tank.

20. The vehicle according to claim 17 further comprising:
means for determining data relating to the volume of the fuel gas in its liquid phase in the gas tank, wherein said model takes into account said determined data relating to the volume of the fuel gas in its liquid phase in the gas tank.

21. A computer program product comprising computer program code stored on a non-transitory computer-readable medium, said computer program product for determining time data relating to a non-combustion outlet process of a fuel gas from a gas tank associated with a vehicle, said computer program product comprising computer instructions to cause one or more computer processors to perform the following operations:
providing a model for the state of said fuel gas in said gas tank; and
determining time data relating to the outlet process of the fuel gas based on said model.

22. The computer program product according to claim 21, wherein said determined time data comprises a time relating to when said fuel gas will start to release from said gas tank, and/or a time relating to when the tank will be substantially emptied from said fuel gas.

23. The computer program product according to claim 21 further comprising the operation of:
determining the pressure and/or the temperature in the gas tank, wherein said model takes into account said determined pressure and/or temperature in the gas tank.
